(19) United States
(12) Patent Application Publication
(10) Pub. No.: US 2026/0183931 A1
(43) Pub. Date: Jul. 2, 2026

(54) MULTI-FUNCTION WORKSTATION PLATFORM

(71) Applicant: Philip Agoglia, Freehold, NJ (US)

(72) Inventor: Philip Agoglia, Freehold, NJ (US)

(21) Appl. No.: 19/412,511

(22) Filed: Dec. 8, 2025

Related U.S. Application Data
(60) Provisional application No. 63/728,711, filed on Dec. 6, 2024.

(51) Int. Cl. B25H 1/04; B25H 1/00; B25H 1/10; B25H 1/16

(52) U.S. Cl. CPC B25H 1/04; B25H 1/005; B25H 1/16; B25H 1/10

(57) ABSTRACT

A multi-function workstation includes a platform with brackets at opposite ends, telescoping legs attachable to the brackets, and a modular tray assembly removably secured to upwardly extending protrusions of the legs. Each telescoping leg has an outer member and an inner member slidable along a longitudinal axis, with apertures and locking pins that fix the leg at selected extension lengths. The modular tray assembly provides slotted compartments, through-holes, and optional circular indentures for tool and material placement, and may include a recessed perimeter lip to prevent displacement during movement. The platform panels may incorporate precision-milled pockets, ribbed surfaces for anti-slip functionality, and fold into a compact configuration for transport. The workstation delivers a stable, portable, and organized work surface adaptable to scaffolding, lifts, carts, or elevated frames, offering ergonomic utility and modular tool organization for technicians and construction professionals.

### BACKGROUND OF THE INVENTION

This application claims priority from U.S. provisional patent application 63/728,711, the contents of which are incorporated by reference herein in its entirety.

### FIELD OF THE DISCLOSURE

The present disclosure relates to workstations, including but not limited to scaffolding, lifts, carts, or any other type of elevated frame, and more particularly to a workstation platform for a mobile assembly such as a cart.

### Description of the Related Art

Elevated work environments such as scaffolding, scissor lifts and carts present challenges for technicians and construction professionals who require stable, portable, and organized work surfaces. Conventional platforms often lack modularity, secure mounting interfaces, and integrated tool support. As a result, workers must rely on improvised surfaces or carry tools by hand, leading to inefficiency and safety risks.

There exists a need for a workstation platform that can be securely mounted to scaffolding rails, lift structures, or leg assemblies, while also providing integrated cavities for tool placement and ribbed surfaces for stability.

### SUMMARY OF THE INVENTION

In one implementation, a workstation includes a platform; a plurality of brackets attached to opposite ends of the platform; a plurality of legs, each of the legs configured to attach to the plurality of brackets, respectively; each leg having an upwardly extending protrusion; and a modular tray assembly configured for removable attachment to at least two of the plurality of legs via the upwardly extending protrusions. The modular tray assembly includes slotted compartments and through-holes for tool placement.

In another implementation, which may be combined with the above implementation, the plurality of brackets each have at least one locking hole; each of the plurality of legs has a plurality of apertures to position the leg at a selected extension length; and a locking pin configured to engage one of the apertures and the locking hole to fix the leg to the bracket at a selected extension length.

In another implementation, which may be combined with one or more of the above implementations, the modular ray assembly includes at least one circular indenture to receive a paint can.

In another implementation, which may be combined with one or more of the above implementations, the slotted compartments and through-holes of the modular tray are configured to receive tools so that a handle of each respective tool extends from the modular tray.

In another implementation, which may be combined with one or more of the above implementations, the modular tray includes a mounting interface comprising a clamp bracket and fastener assembly.

In another implementation, which may be combined with one or more of the above implementations, an upper surface of the modular tray includes a recessed perimeter lip to prevent tool displacement during movement.

In another implementation, which may be combined with one or more of the above implementations, the plurality of legs is four, and at least one pair of the legs are connected with tubes or dowels to form a parallel leg support assembly.

In another implementation, which may be combined with one or more of the above implementations, the modular tray includes an optional support brace that attaches to one of the tubes or dowels of the parallel leg support assembly.

In another implementation, which may be combined with one or more of the above implementations, the modular tray assembly comprises plastic.

In another implementation, which may be combined with one or more of the above implementations, the plastic comprises polyethylene.

In another implementation, which may be combined with one or more of the above implementations, the plurality of legs comprise a telescoping leg assembly coupled to the platform, the telescoping leg assembly including an outer leg member and an inner leg member slidable along a longitudinal axis between a retracted position and an extended position, a locking mechanism configured to selectively fix the inner leg member relative to the outer leg member, and an anti-rotation interface preventing torsion between the members.

In another implementation, which may be combined with one or more of the above implementations, the locking mechanism comprises a spring-biased detent pin engaging apertures spaced at 0.5-inch increments.

In another implementation, which may be combined with one or more of the above implementations, wherein the telescoping leg assembly includes an anti-rotation interface comprising a non-circular cross-section or spline profile.

In another implementation, which may be combined with one or more of the above implementations, sliding interfaces include wear strips or bushings formed of ultra-high-molecular-weight polyethylene.

In another implementation, which may be combined with one or more of the above implementations, the telescoping leg assembly further comprises a cam lever clamp with a wedge shoe and a replaceable friction pad.

In another implementation, which may be combined with one or more of the above implementations, the telescoping leg assembly includes protective boots covering sliding interfaces to reduce ingress of dust and debris.

In another implementation, which may be combined with one or more of the above implementations, the telescoping leg assembly integrates a length scale disposed along the outer leg member and a pointer coupled to the inner leg member to provide visible indexing of extension length.

In another implementation, which may be combined with one or more of the above implementations, the telescoping leg assembly includes a secondary tether anchor for redundant safety attachment to a scaffold frame or cart.

In another implementation, a workstation platform including left hand and right hand polyethylene panels of predetermined thickness, each panel having precision milled pockets and through-holes for tool placement and mounting, the panels being hinged or otherwise foldable into a compact box like configuration with an integrated carry handle and latch, and the pockets being dimensioned to nest specific tools including drills, sanders, and hand tools.

In another implementation, a method of constructing a workstation, includes providing a platform having a plurality of brackets disposed at opposite ends; providing a plurality of telescoping legs, each leg including an outer leg member and an inner leg member slidable along a longitudinal axis, the inner leg member having a plurality of apertures spaced along at least a portion thereof; attaching each of the plurality of telescoping legs to a respective bracket of the platform; inserting a locking pin through a bracket hole and into one of the apertures of the telescoping leg to fix the leg at a selected extension length; providing a modular tray assembly having slotted compartments and through-holes for tool placement; forming upwardly extending protrusions on at least two of the telescoping legs; and attaching the modular tray assembly to the upwardly extending protrusions of the telescoping legs, wherein the modular tray assembly includes a recessed perimeter lip to prevent tool displacement during movement.

In another implementation, a kit for constructing a workstation, includes: a platform having a plurality of brackets disposed at opposite ends; a plurality of telescoping legs, each leg including an outer leg member and an inner leg member slidable along a longitudinal axis, the inner leg member having a plurality of apertures spaced along at least a portion thereof; a plurality of locking pins configured to engage one of the apertures and a corresponding bracket hole to fix each telescoping leg at a selected extension length; a modular tray assembly configured for removable attachment to upwardly extending protrusions of at least two of the telescoping legs, the modular tray assembly including slotted compartments and through-holes for tool placement; and fastener components selected from clamps, dowels, or braces for securing the modular tray assembly to the telescoping legs; wherein the kit is configured such that, upon assembly, the workstation provides a stable platform with adjustable leg height and integrated tool organization features.

In another implementation, the disclosure is directed to a left-hand and right-hand workstation platform assembly made from a polyethylene plate have a predetermined range of thickness, each featuring precision-cut pockets, mounting holes, and rib structures. The platform includes a support arm with integrated carry handle, a two-inch square cut-out for scaffold rail seating, curved cut-outs and ribbed surfaces for unit stabilization, multiple two-inch through holes and six-point-eight-five millimeter by three-eighths inch deep pockets for tool placement, a foldable configuration with dimensions of sixteen inches wide by twenty-nine inches long by five inches high, and an optional folding support leg for ground deployment.

### BRIEF DESCRIPTION OF THE DRAWINGS

FIG. 1 is a top view of the workstation according to the an illustrated implementation.

FIG. 2 is a front view of the workstation platform illustrating the modular tray.

FIG. 3 is a front view of the a top view of the workstation platform illustrating the modular tray oriented in a different direction than in FIG. 2.

FIG. 4 is a front view of the workstation platform showing structural reinforcement features.

FIG. 5 is a perspective view of another implementation of the workstation platform

FIG. 6 is a tool placement diagram illustrating nesting cavities in the platform for drills, sanders, and hand tools within the modular tray assembly.

FIG. 7A is a detail view of the telescoping leg assembly showing the detent pin.

FIG. 7B shows the telescoping leg assembly with a locking clamp, and bracket interface for securing the leg to the platform.

FIG. 8A is a schematic of the modular tray for the workstation platform according to one implementation according to the present disclosure.

FIG. 8B is another schematic of the modular tray for the workstation platform according to an implementation according to the present disclosure, identifying some additional distances between apertures, etc., not shown in FIG. 8A.

FIG. 8C shows the modular tray of FIGS. 8A and 8B identifying some of the indentures and apertures for receiving items such as tools, cans, etc.

### DETAILED DESCRIPTION

As described herein, the term “removably attachable” and derivatives thereof shall be used to describe a situation wherein two or more objects are joined together in a non-permanent manner, so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The detailed description of exemplary and preferred embodiments is presented for purposes of illustration and disclosure in accordance with the requirements of the law. It is not intended to be exhaustive nor to limit the disclosure to the precise form(s) described, but only to enable others skilled in the art to understand how the disclosure may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the disclosure be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for . . . ” and no method or process step herein is to be construed under those provisions unless the step, or steps, are expressly recited using the phrase “step(s) for . . . ”

In the following description, numerous specific details are set forth to clearly describe various specific embodiments disclosed herein. One skilled in the art, however, will understand that the presently claimed disclosure may be practiced without all of the specific details discussed below. In other instances, well-known features have not been described so as not to obscure the novel aspects of the disclosure.

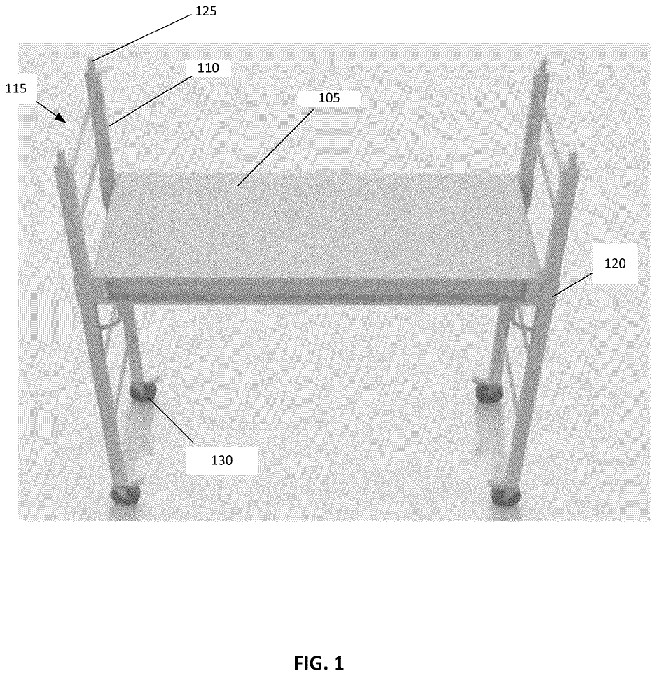

Referring to FIG. 1, a top view of the workstation is shown according to an illustrated implementation. The platform 105 provides a stable support surface and includes brackets 120 at opposite ends for attachment of legs 110, which may be telescoping legs. In some implementations, the legs 110 are connected in pairs by dowels 115 or similar. The legs 110 may have an upwardly extending protrusion 125, upon which a modular tray may be received. Wheels such as locking casters 130 are also shown. The workstation may have many different sizes and functions, e.g., a scaffolding platform, a tool cart, are just two non-limiting possible examples.

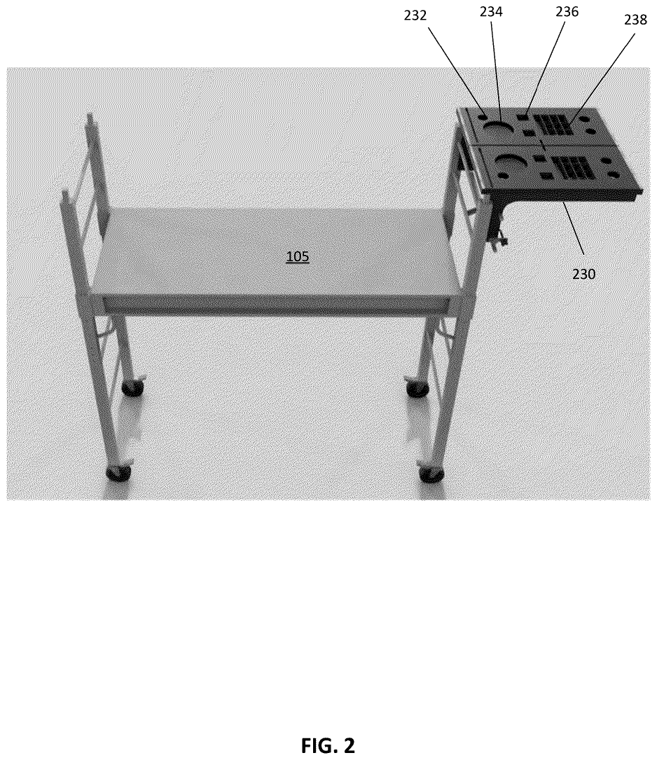

FIG. 2 illustrates a front view of the workstation, with the platform 105 and the modular tray 230. The modular tray 230 includes slotted compartments 238 and through-holes 232 dimensioned to receive tools and accessories. Square holes 236, and indentures 234 for holding round items in place such as paint cans are also shown. The modular tray 230 in this implementation attached to the upwardly extending protrusions 225 (shown in FIG. 1) and also may have an optional stabilizer bar such as a support brace attached to one of the dowels 115 (FIG. 1) or the legs 110 or platform 105. The modular tray 230 is thus removably attachable to/from the upwardly extending protrusions of the legs 110.

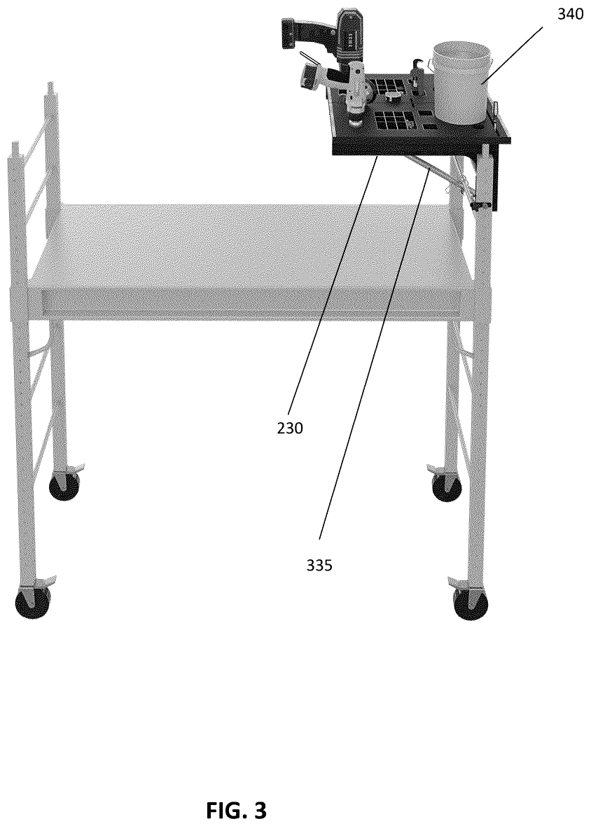

FIG. 3 shows a front and top view of the workstation platform with the modular tray 230 oriented in a different direction than shown in FIG. 2. In this particular implementation, an optional support brace 335 attaches between the modular tray 230 and either one of the dowels 115, the brackets, or the platform to provide additional support for extra heavy objects. However, it is to be understood that the support brace is optional and is not required to use the workstation platform. For example, the modular tray 230 may attach to just the upward extending protrusions. The strength of the legs may support the modular tray with the tools, accessories, etc., without the support brace. It is also within the scope of the disclosure that the modular tray 230 may snap on to the upwardly extending protrusions of the legs by being press fit, snap fit, or an interlocking mechanism, just to name some non-limiting examples. The image in FIG. 3 demonstrates the versatility of the modular tray 230 and its ability to be mounted in multiple positions relative to the platform 105 and legs 110. Items such as a paint can 340 is shown along with power tools. A non-exhaustive list of items include but are in no way limited to paint cans in gallon, quart, and pint sizes, cordless drills, assorted screwdrivers, pliers, lineman pliers, an organizer for screws, an organizer for fittings typically used by plumbers or electricians, a hammer(s), pipe wrenches, taping knives, paint roller, paint brushes, and a ruler or one or both ends and for example, may extend from 1 to 30 inches, 29 inches, 3 feet, or may also have metric markings and for example, 1 meter. The aforementioned are just a few possible examples. It is to be understood that the modular tray may be larger or smaller than shown.

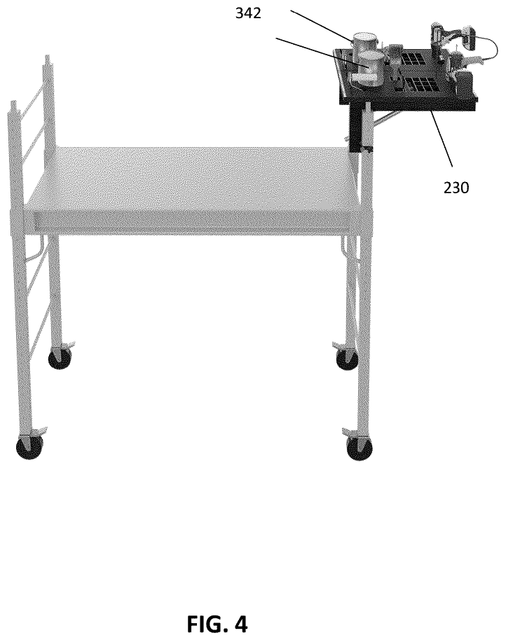

FIG. 4 depicts a front view of the workstation platform face in a different orientation than in FIG. 3. Reinforcement members and ribbed surfaces are visible, providing stability and load-bearing capacity in elevated work environments. Shown are two cans 342 of paint and some tools. For example, depending on the weight of the items being arranged on the modular tray, the orientation may face outward away from the footprint of the platform, or inward, within the footprint of the platform.

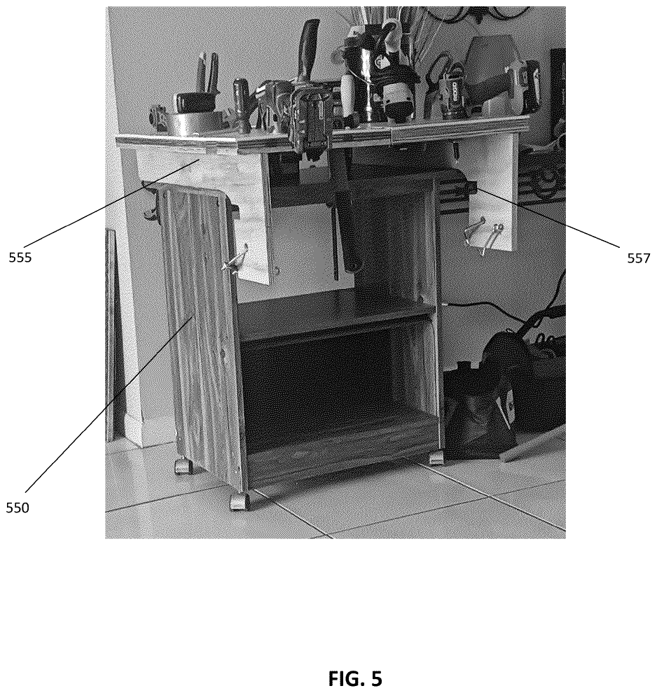

FIG. 5 is a perspective view of another implementation of the workstation platform. This view illustrates alternative structural arrangements and component configurations, showing variations in tray attachment, leg positioning, or reinforcement geometry. The platform 555 has a left side and a right side that may be one contiguous piece, or may join by latches or protrusions and receiving holes, that may be similar to a table extension. The platform 555 has a partial slot or cutout 557 to fit into a table of as cart portion 550.

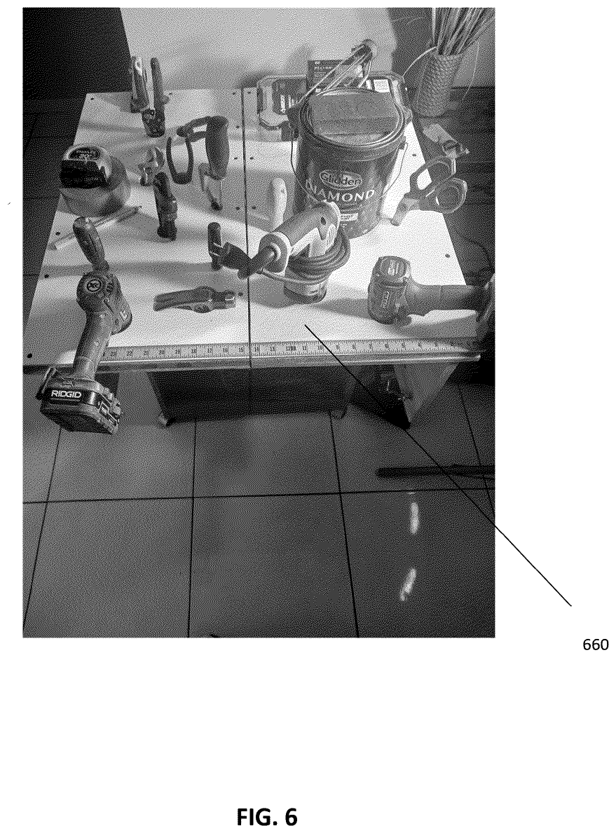

FIG. 6 is an overhead view of tools on and partially within platform 555. Cavities are dimensioned to receive drills, sanders, and hand tools, with handles oriented for easy grasp and removal. The diagram demonstrates the organized layout of tool pockets and the secure retention of tools during movement.

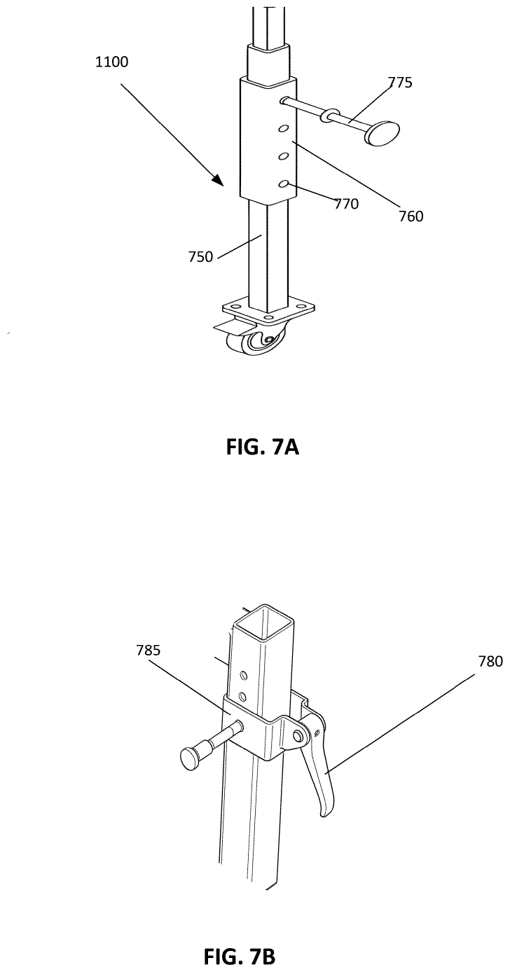

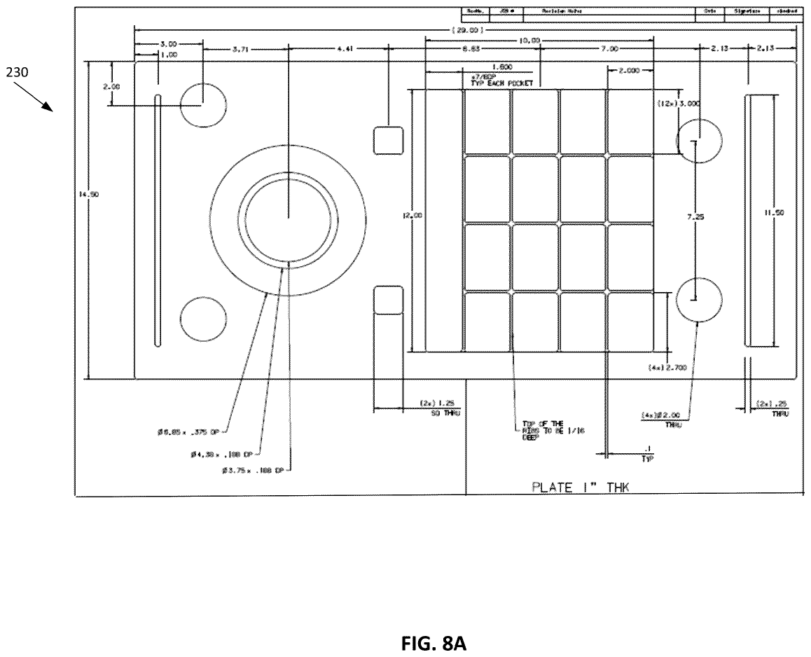

FIGS. 7A and 7B provides a detailed view of the telescoping leg assembly 1100. The assembly includes an outer leg member 760, which may receive an inner leg member 750 slidable along a longitudinal axis. A detent pin 775 engages apertures 770 along the inner leg to fix the leg at a selected extension length. FIG. 7B shows an optional locking clamp 780 and bracket interface 785 that may be used to secure the leg to the platform, ensuring stability and adjustability in use. It is to be understood that a mechanism such as shown in FIG. 7A may be used without the locking clamp 780 and bracket interface. It is also to be understood that FIG. 7, like all of FIGS. 1 to 6, is being provided for illustrative purposes only, and the appended claims are not limited to the depictions shown and described.

In some implementations, the modular tray 230 of the workstation platform is constructed of high-density polyethylene plate one inch thick. The thickness or the material used to may the modular tray 230 may be different for different use cases. Mounting features include four two-inch diameter through holes for bolt or pin mounting, two one-and-one-quarter inch and two one-quarter inch through holes for accessory attachment, and four two-point-seven inch holes for structural anchoring. Tool pockets include twelve three-inch wide cavities for hand tools, as well as six-point-eight-five millimeter by three-eighths inch deep, four-point-three-eight millimeter by three-sixteenths inch deep, and three-point-seven-five millimeter by three-sixteenths inch deep cavities for nesting power tools such as drills and sanders. Ribbed support surfaces are raised to a depth of one-sixteenth inch to provide anti-slip functionality. The platform geometry includes left-hand and right-hand panels that mirror each other for bilateral deployment, with integrated carry handles and folding leg interfaces. When folded, the platform measures approximately sixteen inches wide by twenty-nine inches long by five inches high, forming a compact box-like configuration for transport and storage.

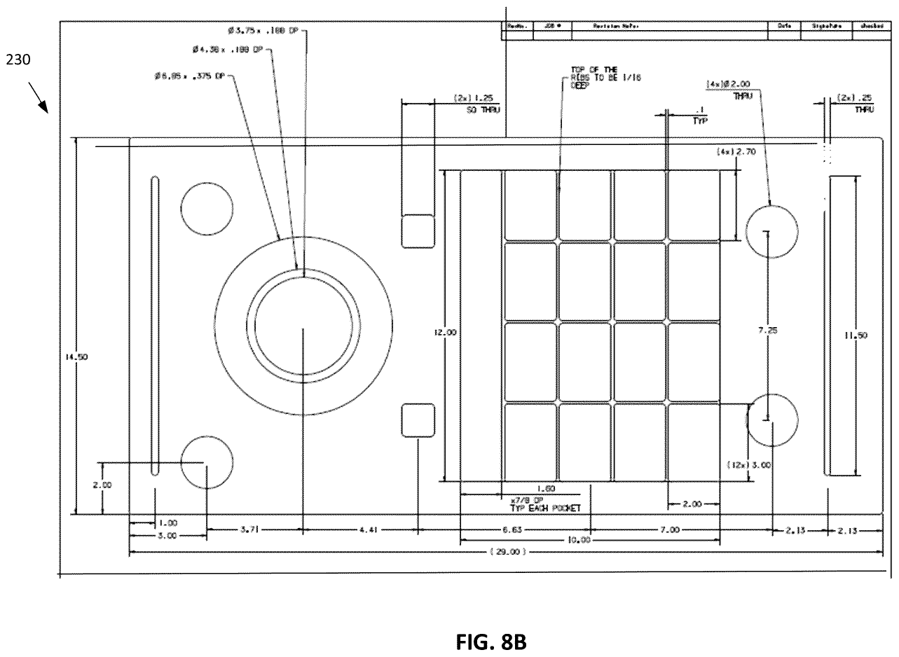

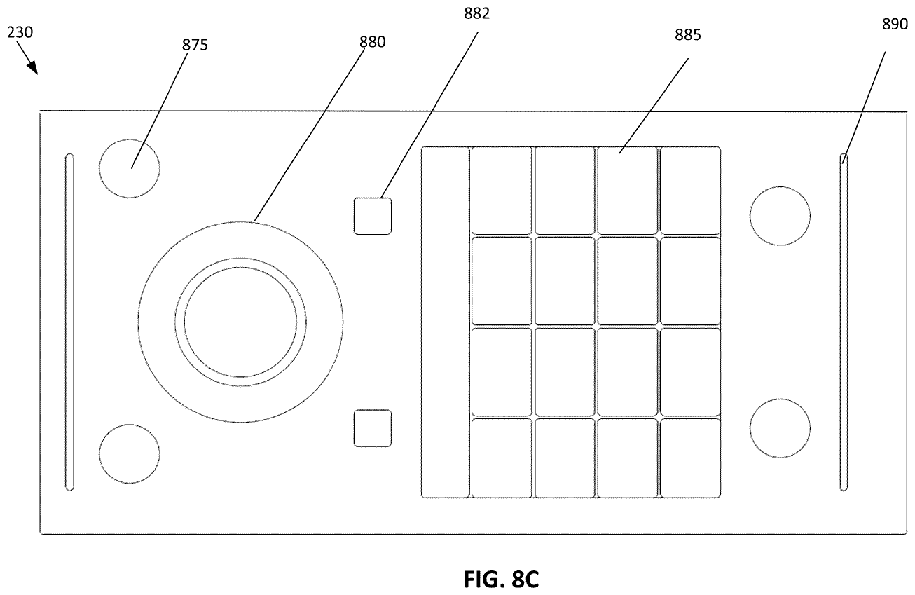

FIGS. 8A and 8B are schematics of the modular tray 230 for the workstation platform according to one implementation according to the present disclosure. FIG. 8B shows some distances between openings, etc., not shown in FIG. 8A. It is to be understood that the dimensions are provided for illustrative purposes only, and do not limited the appended claims. For example, while dimensions are shown in inches, metric units may be used. The modular tray may be thicker or thinner depending on the use case, and the distance between items to be stored thereon may be different. The entire perimeter of the modular tray 230 may be a different size than shown.

FIG. 8C shows the modular tray 230 of FIGS. 8A and 8B identifying some of the indentures and openings for receiving items such as tools, cans, etc. For example, 875 shows smaller diameter hole that may be used for tools with thick diameters including but not limited to screwdrivers, pliers, etc. The circle 880 may be suitable for arranging different size cans or buckets, particularly with its concentric arrangement. As shown by the opening 882, various shapes may be used other than round, or oblong. There is also an array of slots 885 that while shown as being similarly sized, may be varied in size. Item 890 is a long slot that may be suitable for wiring from some of the nearby tools in the opening. The modular tray 230 may also have a lip near the edges, slightly raised in height to prevent items from falling off the modular tray. I tis to be understood that these are just a few of the possible configurations for the modular tray 230.

1. A workstation comprising:
a platform;
a plurality of brackets attached to opposite ends of the platform;
a plurality of legs, each of the legs configured to attach to the plurality of brackets, respectively;
each leg having an upwardly extending protrusion; and
a modular tray assembly configured for removable attachment to at least two of the plurality of legs via the upwardly extending protrusions;
wherein the modular tray assembly includes slotted compartments and through-holes for tool placement.

2. The workstation according to claim 1, wherein the plurality of brackets each have at least one locking hole;
each of the plurality of legs has a plurality of apertures to position the leg at a selected extension length; and
a locking pin configured to engage one of the apertures and the locking hole to fix the leg to the one of the plurality of brackets at a selected extension length.

3. The workstation according to claim 1, wherein the modular tray assembly includes at least one circular indenture to receive a paint can.

4. The workstation according to claim 1, wherein the slotted compartments and through-holes of the modular tray assembly are configured to receive tools so that a handle of each respective tool extends from the modular tray.

5. The workstation according to claim 1, wherein the modular tray assembly includes a mounting interface comprising a clamp bracket and fastener assembly.

6. The workstation according to claim 1, wherein an upper surface of the modular tray includes a recessed perimeter lip to prevent tool displacement during movement.

7. The workstation according to claim 1, wherein the plurality of legs is four, and at least one pair of the legs are connected with tubes or dowels to form a parallel leg support assembly.

8. The workstation according to claim 7, wherein the modular tray assembly includes a support brace that attaches to one of the tubes or dowels of the parallel leg support assembly.

9. The workstation according to claim 1, wherein the modular tray assembly comprises plastic.

10. The workstation according to claim 9, wherein the plastic comprises polyethylene.

11. The workstation according to claim 1, where the plurality of legs comprise a telescoping leg assembly coupled to the platform, the telescoping leg assembly including an outer leg member and an inner leg member slidable along a longitudinal axis between a retracted position and an extended position, a locking mechanism configured to selectively fix the inner leg member relative to the outer leg member.

12. The workstation according to claim 11, wherein the locking mechanism comprises a spring-biased detent pin engaging apertures spaced at 0.5-inch increments.

13. The workstation of claim 11, wherein the telescoping leg assembly includes an anti-rotation interface comprising a non-circular cross-section or spline profile.

14. The workstation of claim 11, wherein sliding interfaces include wear strips or bushings formed of ultra-high-molecular-weight polyethylene.

15. The workstation of claim 11, wherein the telescoping leg assembly further comprises a cam lever clamp with a wedge shoe and a replaceable friction pad.

16. The workstation of claim 11, wherein the telescoping leg assembly includes protective boots covering sliding interfaces to reduce ingress of dust and debris.

17. The workstation of claim 11, wherein the telescoping leg assembly integrates a length scale disposed along the outer leg member and a pointer coupled to the inner leg member to provide visible indexing of extension length.

18. The workstation of claim 11, wherein the telescoping leg assembly includes a secondary tether anchor for redundant safety attachment to a scaffold frame or cart.

19. A workstation platform including left-hand and right-hand polyethylene panels of predetermined thickness, each panel having precision-milled pockets and through-holes for tool placement and mounting, the left-hand and right-hand polyethylene panels being hinged or otherwise foldable into a compact box-like configuration with an integrated carry handle and latch, and the pockets being dimensioned to nest specific tools including drills, sanders, and hand tools.

20. A method of constructing a workstation, comprising:
providing a platform having a plurality of brackets disposed at opposite ends;
providing a plurality of telescoping legs, each leg including an outer leg member and an inner leg member slidable along a longitudinal axis, the inner leg member having a plurality of apertures spaced along at least a portion thereof;
attaching each of the plurality of telescoping legs to a respective bracket of the platform;
inserting a locking pin through a bracket hole and into one of the apertures of the telescoping leg to fix the leg at a selected extension length;
providing a modular tray assembly having slotted compartments and through-holes for tool placement;
forming upwardly extending protrusions on at least two of the telescoping legs; and
attaching the modular tray assembly to the upwardly extending protrusions of the telescoping legs, wherein the modular tray assembly includes a recessed perimeter lip to prevent tool displacement during movement.

21. A kit for constructing a workstation, comprising:
a platform having a plurality of brackets disposed at opposite ends;
a plurality of telescoping legs, each leg including an outer leg member and an inner leg member slidable along a longitudinal axis, the inner leg member having a plurality of apertures spaced along at least a portion thereof;
a plurality of locking pins configured to engage one of the apertures and a corresponding bracket hole to fix each telescoping leg at a selected extension length;
a modular tray assembly configured for removable attachment to upwardly extending protrusions of at least two of the telescoping legs, the modular tray assembly including slotted compartments and through-holes for tool placement; and
fastener components selected from clamps, dowels, or braces for optional securing of the modular tray assembly to the telescoping legs,
wherein the kit is configured such that, upon assembly, the workstation provides a stable platform with adjustable leg height and integrated tool organization features.
